(19) United States
(12) Patent Application Publication
(10) Pub. No.: US 2023/0402663 A1
(43) Pub. Date: Dec. 14, 2023

(54) POWER SUPPLY APPARATUS AND COMMUNICATION APPARATUS

(71) Applicant: MURATA MANUFACTURING CO., LTD., Kyoto (JP)

(72) Inventors: Moriaki OKUNO, Kyoto (JP); Mikio YAMAMOTO, Kyoto (JP); Rie WATANABE, Kyoto (JP)

(21) Appl. No.: 18/239,473

(22) Filed: Aug. 29, 2023

Related U.S. Application Data
(63) Continuation of application No. PCT/JP2021/047218, filed on Dec. 21, 2021.

(30) Foreign Application Priority Data
Mar. 1, 2021 (JP) 2021-032024

(51) Int. Cl. H01M 10/42; H01M 6/16; H01M 10/0525; H01M 50/512; H01M 50/109; H01M 4/50; H01M 4/58; H01M 4/525

(52) U.S. Cl. CPC H01M 10/425; H01M 6/16; H01M 10/0525; H01M 50/512; H01M 50/109; H01M 4/502; H01M 4/5825; H01M 4/525; H02J 7/0029

(57) ABSTRACT

A power supply apparatus includes a primary battery, a secondary battery, and an output terminal. The secondary battery is coupled in parallel with the primary battery. The output terminal outputs electric power from the secondary battery to an outside. A discharge capacity of the primary battery is larger than a discharge capacity of the secondary battery.

### CROSS REFERENCE TO RELATED APPLICATIONS

The present application is a continuation of PCT patent application no. PCT/JP2021/047218, filed on Dec. 21, 2021, which claims priority to Japanese patent application no. 2021-032024, filed on Mar. 1, 2021, the entire contents of which are incorporated herein by reference.

### BACKGROUND

The present technology relates to a power supply apparatus and a communication apparatus.

In recent information society, performing communication between various apparatuses to transmit and receive data between the apparatuses has become more common. An increase in frequency of communication between the apparatuses and an increase in the amount of data in the communication have promoted the development of power supplies to be mounted on the apparatuses, and various technical proposals have been made.

### SUMMARY

The present technology relates to a power supply apparatus and a communication apparatus.

Here, desirable as a power supply apparatus to be mounted on a portable and small-sized communication apparatus is a power supply apparatus having a large capacity and a larger output current under a high load in order to cope with frequent and high-load communication.

It is therefore desirable to provide a power supply apparatus that has a high volume energy density and makes it possible to perform pulse discharging a greater number of times.

A power supply apparatus according to an embodiment of the present technology includes a primary battery, a secondary battery, and an output terminal. The secondary battery is coupled in parallel with the primary battery. The output terminal outputs electric power from the secondary battery to an outside. A discharge capacity of the primary battery is larger than a discharge capacity of the secondary battery.

A communication apparatus according to another embodiment of the present technology includes a power supply apparatus. The power supply apparatus includes a primary battery, a secondary battery, and an output terminal. The secondary battery is coupled in parallel with the primary battery. The output terminal outputs electric power from the secondary battery to an outside. A discharge capacity of the primary battery is larger than a discharge capacity of the secondary battery.

The power supply apparatus according to an embodiment includes the primary battery, and the secondary battery coupled in parallel with the primary battery, and makes it possible to output the electric power from the secondary battery to the outside. The power supply apparatus according to an embodiment thus makes it possible to charge the secondary battery by the primary battery having the discharge capacity larger than that of the secondary battery. Accordingly, it is possible for the power supply apparatus to increase a volume energy density of the power supply apparatus and to perform pulse discharging a greater number of times.

Note that effects of the present technology are not necessarily limited to those described herein and may include any of a series of suitable effects in relation to the present technology.

### BRIEF DESCRIPTION OF THE FIGURES

FIG. 1 is an equivalent circuit diagram illustrating a circuit configuration of a power supply apparatus according to an embodiment of the present technology.

FIG. 2 is a graph illustrating an example of a discharge characteristic of a primary battery when used alone.

FIG. 3 is a graph illustrating an example of a discharge characteristic of a secondary battery when used alone.

FIG. 4 is a graph illustrating an example of a discharge characteristic of a secondary battery included in a power supply apparatus according to an example.

FIG. 5 is a schematic vertical sectional view of a configuration example of the power supply apparatus according to an embodiment of the present technology.

FIG. 6 is an equivalent circuit diagram of a power supply apparatus according to Example 1.

FIG. 7 is an equivalent circuit diagram of a power supply apparatus according to Example 5.

FIG. 8 is an equivalent circuit diagram of a power supply apparatus according to each of Comparative examples 2 and 3.

FIG. 9 is an equivalent circuit diagram of a power supply apparatus according to Comparative example 4.

### DETAILED DESCRIPTION

One or embodiments of the present technology are described below in further detail including with reference to the drawings.

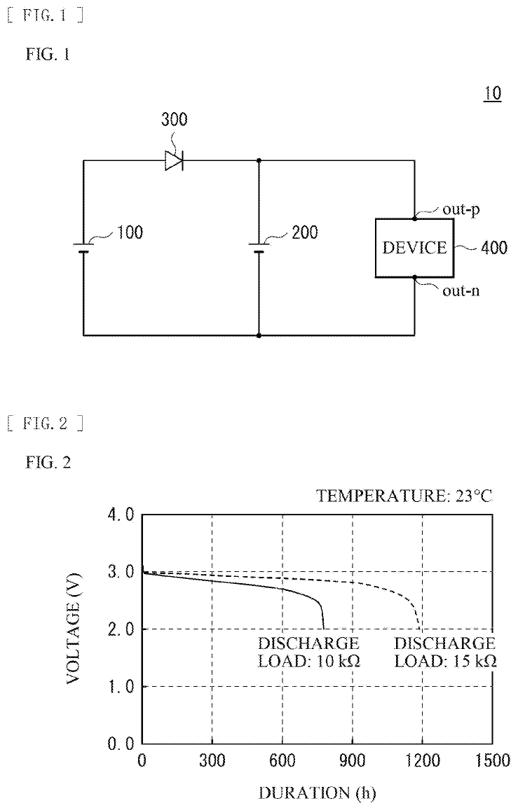

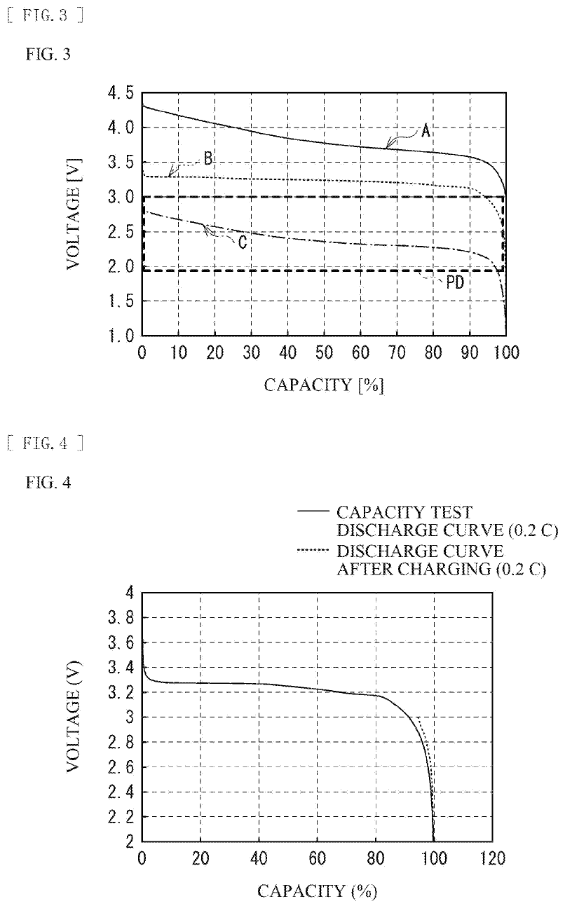

First, referring to FIG. 1, a power supply apparatus according to an embodiment of the present technology will be described. FIG. 1 is an equivalent circuit diagram illustrating a circuit configuration of a power supply apparatus 10 according to an embodiment.

As illustrated in FIG. 1, the power supply apparatus 10 includes a primary battery 100, a secondary battery 200, and a rectifier 300, and supplies electric power to a device 400 from a positive output terminal out-p and a negative output terminal out-n.

The primary battery 100 is a chemical battery that allows for only direct-current power discharge, and the secondary battery 200 is a chemical battery that allows for repeated discharge by being charged. The primary battery 100 and the secondary battery 200 are coupled in parallel, and the secondary battery 200 having an internal resistance lower than that of the primary battery 100 is charged by the primary battery 100. Further, the electric power charged in the secondary battery 200 is outputted to the device 400 electrically coupled to the positive output terminal out-p and the negative output terminal out-n.

Although the primary battery 100 has a discharge capacity larger than that of the secondary battery 200, the primary battery 100 tends to have a high internal resistance and a small output current. In contrast, although the secondary battery 200 has an output current larger than that of the primary battery 100, the secondary battery 200 has to be charged prior to use, and tends to have a small discharge capacity. It is possible for the power supply apparatus 10 according to an embodiment to have both the current output of the secondary battery 200 and the discharge capacity of the primary battery 100 by using, in combination, the primary battery 100 and the secondary battery 200 coupled in parallel. Such a configuration makes it possible for the power supply apparatus 10 according to an embodiment to perform pulse discharging from the secondary battery 200 using the discharge capacity of the primary battery 100, and to perform the pulse discharging a greater number of times.

The rectifier 300 has a rectifying action that sets a direction in which a current flows from the primary battery 100 to the secondary battery 200 to a forward direction, and is provided between the primary battery 100 and the secondary battery 200. Specifically, the rectifier 300 is a device that causes the current to flow from the primary battery 100 toward the secondary battery 200, but hardly causes the current to flow from the secondary battery 200 toward the primary battery 100. Providing the rectifier 300 makes it possible for the power supply apparatus 10 to prevent occurrence of discharge from the secondary battery 200 toward the primary battery 100. The rectifier 300 may be any of various diodes including, without limitation, a Schottky barrier diode.

The device 400 is an external device coupled to the power supply apparatus 10, and supplied with the electric power from the power supply apparatus 10. The device 400 is coupled to the positive output terminal out-p and the negative output terminal out-n to be supplied with the electric power from the secondary battery 200.

The power supply apparatus 10 having the above-described configuration is coupled to the device 400 to thereby first output the current from both the primary battery 100 and the secondary battery 200 to the device 400. Here, an internal resistance (internal impedance) of the primary battery 100 is much higher than an internal resistance (internal impedance) of the secondary battery 200. Accordingly, the current outputted from the primary battery 100 to the device 400 is smaller than the current outputted from the secondary battery 200 to the device 400. Further, providing the rectifier 300 causes, when a voltage of the primary battery 100 becomes lower than a voltage of the secondary battery 200 due to load variation or other reasons, discharging from the primary battery 100 to be automatically stopped, and causes substantially no current to flow from the primary battery 100 to the device 400. In the power supply apparatus 10, the current is thus substantially outputted from the secondary battery 200 to the device 400.

In other words, the power supply apparatus 10 makes it possible to supply the electric power to the device 400 from the secondary battery 200 that is constantly charged by the primary battery 100. Specifically, the secondary battery 200 is constantly in a float state, and is thus constantly charged by the primary battery 100 for an amount of electric power supplied to the device 400. Such a configuration allows the secondary battery 200 to be charged with the electric power from the primary battery 100 prior to occurrence of overdischarging as long as an electric capacity stored in the primary battery 100 does not run out, and thus makes it possible to prevent the occurrence of overdischarging without providing a discharge control circuit.

Accordingly, the power supply apparatus 10 according to an embodiment makes it possible to obtain the discharge capacity of the primary battery 100 that is larger than the discharge capacity of the secondary battery 200, and to perform the pulse discharging derived from an output characteristic of the secondary battery 200. Such a configuration makes it possible for the power supply apparatus 10 to supply the electric power to the device 400 for a long period of time without charging the secondary battery 200 from an outside. Further, such a configuration also makes it possible for the power supply apparatus 10 to perform the pulse discharging on the device 400 a greater number of times than when the secondary battery 200 is used alone.

Further, it is possible for the secondary battery 200 to store larger electric power as compared with another storage device such as a capacitor. It is thus possible for the power supply apparatus 10 according to an embodiment to allow a current to flow for a sufficient period of time also in a case of an instantaneous high load. By way of example, it is possible for the power supply apparatus 10 to allow a several-hundred-milliampere peak-to-peak current to flow for several seconds, also in a case of the instantaneous high load.

Next, referring to FIG. 2 and FIG. 3, an example of an electric characteristic of each of the primary battery 100 and the secondary battery 200 included in the power supply apparatus 10 will be described. FIG. 2 is a graph illustrating an example of a discharge characteristic of the primary battery 100 when used alone. FIG. 3 is a graph illustrating an example of a discharge characteristic of the secondary battery 200 when used alone.

The primary battery 100 may be a primary battery such as a lithium manganese dioxide battery as illustrated in FIG. 2 having a discharge region PD within a range from 3.0 V to 2.0 V both inclusive. The lithium manganese dioxide battery is a primary battery in which a positive electrode includes manganese dioxide and a negative electrode includes lithium.

However, the primary battery 100 may be another kind of primary battery as long as the primary battery 100 satisfies a relationship of the electric characteristic with the secondary battery 200 to be described later. For example, the primary battery 100 may be a lithium thionyl chloride battery in which the positive electrode includes thionyl chloride and the negative electrode includes lithium. Further, the primary battery 100 may be an alkaline manganese dry battery in which the positive electrode includes manganese dioxide and graphite powder and the negative electrode includes zinc.

The secondary battery 200 may be a secondary battery in which at least a portion of a discharge curve overlaps the discharge region PD of the primary battery 100. In other words, the secondary battery 200 may be a secondary battery whose discharge curve intersects a discharge curve of the primary battery 100.

Here, the discharge curve of the primary battery 100 and the discharge curve of the secondary battery 200 are respectively obtained when the primary battery 100 and the secondary battery 200 are discharged at 0.01 C at a standard temperature (20° C.). Further, the discharge capacity of the primary battery 100 is obtained when the primary battery 100 is discharged at 0.01 C within a predetermined voltage range corresponding to each combination of the positive electrode and the negative electrode of the primary battery 100, and the discharge capacity of the secondary battery 200 is obtained when the secondary battery 200 is discharged at 0.01 C within a predetermined voltage range corresponding to each combination of the positive electrode and the negative electrode of the secondary battery 200.

Note that the predetermined voltage ranges are as presented in Table 1 for batteries of the same kinds as those presented in Table 1 of Examples to be described later herein. Further, for a battery whose specifications are defined in the battery body, the attached document, etc., out of the batteries whose kinds are not presented in Table 1 to be described later, a voltage range or a rated capacity defined in the specifications may be referred to as the predetermined voltage range or the discharge capacity. In addition, out of the batteries whose kinds are not presented in Table 1 and whose specifications are not defined in the battery body, the attached document, etc., a battery that is a secondary battery having the following configuration may have the predetermined voltage range of from 4.2 V to 2.0 V both inclusive. The configuration of the secondary battery is as follows: the positive electrode includes an active material including lithium nickel oxide and a layered rock-salt transition metal oxide including nickel and manganese as main components, e.g., Li(Ni, Co, Mn)O₂; and the negative electrode includes an active material including carbon or silicon.

If the voltage of the secondary battery 200 is lower than the voltage of the primary battery 100 at least in a portion of the respective discharge curves of the secondary battery 200 and the primary battery 100, coupling the secondary battery 200 in parallel with the primary battery 100 makes it possible for the secondary battery 200 to be charged by the primary battery 100 without boosting. In such a case, it is possible for the power supply apparatus 10 to charge the secondary battery 200 by the primary battery 100 without providing a voltage booster circuit between the secondary battery 200 and the primary battery 100. Further, if the voltage of the secondary battery 200 is higher than the voltage of the primary battery 100 at least in a portion of the respective discharge curves of the secondary battery 200 and the primary battery 100, the secondary battery 200 is not fully charged by charging with use of the primary battery 100, and the charging automatically stops in the middle. In such a case, it is possible for the power supply apparatus 10 to suppress overcharging of the secondary battery 200 without providing a charge control circuit.

In addition, the discharge curve of the secondary battery 200 preferably intersects the discharge curve of the primary battery 100 at a point at which a depth of discharge of the primary battery 100 is greater than 0% and less than or equal to 99%. In such a case, it is possible for the secondary battery 200 to be stably charged by the primary battery 100 by being coupled in parallel with the primary battery 100 and thus charged at the depth of discharge commonly used by the primary battery 100.

Specifically, in the graph illustrated in FIG. 3, the discharge curve of the secondary battery 200 is preferably a discharge curve indicated by B or C, rather than a discharge curve indicated by A. The secondary battery 200 having the discharge curve indicated by B or C intersects the discharge curve of the primary battery 100. Thus, it is possible for the secondary battery 200 having discharge curve indicated by B or C to be charged by the primary battery 100 without the voltage booster circuit, and to reduce a possibility of overcharging even without the charge control circuit.

Examples of the secondary battery 200 by which the discharge curve indicated by B is obtainable include a lithium-ion secondary battery in which a positive electrode includes a lithium-containing compound having an olivine structure and a negative electrode includes one or more of graphite, a silicon-containing compound, or a tin-containing compound.

Referring now to FIG. 4, as one specific example, a description is given of the power supply apparatus 10 that includes the lithium manganese dioxide battery as the primary battery 100, and the lithium-ion secondary battery in which the positive electrode includes lithium iron phosphate having the olivine structure and the negative electrode includes graphite as the secondary battery 200. FIG. 4 is a graph illustrating an example of a discharge characteristic of the secondary battery 200 included in the power supply apparatus 10 according to a specific example.

As illustrated in FIG. 4, in the power supply apparatus 10 according to the specific example, the electric capacity of the secondary battery 200 to be charged by the primary battery 100 is determined by the discharge curve of the primary battery 100 and the discharge curve of the secondary battery 200. Specifically, the electric capacity of the secondary battery 200 to be charged by the primary battery 100 is preferably within a range from about 1% to 10% of a total discharge capacity of the secondary battery 200 in the end stage of discharging. This makes it possible for the power supply apparatus 10 to perform discharging at 150 mA under a temperature of 25° C. for one second even when the depth of discharge of the secondary battery 200 is 90%. This also makes it possible for the power supply apparatus 10 to maintain the discharge voltage at 2.0 V or higher during the discharging.

In such a power supply apparatus 10, the secondary battery 200 is charged only about 1% to 10% of the total discharge capacity. This prevents easy occurrence of overdischarging without providing the discharge control circuit, and allows a decrease in the discharge capacity due to repetition of charging and discharging to be extremely small. Further, the secondary battery 200 coupled in parallel with the primary battery 100 is constantly in the float state, and is constantly charged by the primary battery 100. Accordingly, the charged electric capacity does not run out, and it is possible to prevent easy occurrence of overdischarging without providing the discharge control circuit. In addition, it is possible to allow the secondary battery 200 to be automatically charged within a range of the electric capacity of about 1% to 10% of the total discharge capacity by the primary battery 100 coupled in parallel, without the voltage booster circuit being interposed therebetween.

It is thus possible to configure the power supply apparatus 10 according to an embodiment by a simple circuit without providing the charge control circuit, the discharge control circuit, and the voltage booster circuit. This makes it possible to reduce the cost of parts included in these circuits and electric power loss caused by these circuits, and to reduce the size of the power supply apparatus 10.

Note that, as the power supply apparatus 10 according to another specific example, a power supply apparatus including a lithium primary battery as the primary battery 100 and the lithium-ion secondary battery as the secondary battery 200 may be exemplified. Similarly in the power supply apparatus 10 according to the other specific example, it is also possible to perform high-output pulse discharging a greater number of times.

Next, referring to FIG. 5, a configuration example of the power supply apparatus 10 according to an embodiment will be described. FIG. 5 is a schematic vertical sectional view of the configuration example of the power supply apparatus 10 according to an embodiment.

As illustrated in FIG. 5, the power supply apparatus 10 may include the primary battery 100 and the secondary battery 200 that are bonded to each other. Respective planar shapes of the primary battery 100 and the secondary battery 200 are substantially identical to each other. The term “substantially identical” means that, for example, the planar shapes are similar and a difference in sizes of the planar shapes is within 10%.

The primary battery 100 may have a flat columnar shape, that is, what is called a coin shape or a button shape. Specifically, the primary battery 100 may include a battery device 130, a first electrode can 110, and a second electrode can 120. The battery device 130 stores electric power as chemical energy. The first electrode can 110 has a based cylindrical shape. The second electrode can 120 has a lidded cylindrical shape. The second electrode can 120 is crimped at an opening of the first electrode can 110 with a gasket 140 interposed therebetween to contain the battery device 130 between the second electrode can 120 and the first electrode can 110. The first electrode can 110 is coupled to one of a positive electrode or a negative electrode of the battery device 130, and the second electrode can 120 is coupled to the other of the positive electrode or the negative electrode of the battery device 130. Accordingly, the first electrode can 110 and the second electrode can 120 serve as the positive electrode and the negative electrode of the primary battery 100.

In addition, the primary battery 100 may be detachably provided to the power supply apparatus 10 to be replaceable. This makes it possible for the power supply apparatus 10 to recover the stored electric capacity by replacing the primary battery 100, and accordingly to be used repeatedly. It is therefore possible for the power supply apparatus 10 to supply the electric power for a long period of time without frequently charging the secondary battery 200 from the outside, and to supply the electric power again by replacing the primary battery 100.

As with the primary battery 100, the secondary battery 200 may have a flat columnar shape, that is, what is called a coin shape or a button shape. Specifically, the secondary battery 200 may include a battery device 230, a first electrode can 210, and a second electrode can 220. The battery device 230 stores electric power as chemical energy in such a manner as to be chargeable and dischargeable. The first electrode can 210 has a based cylindrical shape. The second electrode can 220 has a lidded cylindrical shape. The second electrode can 220 is crimped at an opening of the first electrode can 210 with a gasket 240 interposed therebetween to contain the battery device 230 between the second electrode can 220 and the first electrode can 210. The first electrode can 210 is coupled to one of a positive electrode or a negative electrode of the battery device 230, and the second electrode can 220 is coupled to the other of the positive electrode or the negative electrode of the battery device 230. Accordingly, the first electrode can 210 and the second electrode can 220 serve as the positive electrode and the negative electrode of the secondary battery 200.

The power supply apparatus 10 may include the primary battery 100 and the secondary battery 200 having the above-described shapes, and may thus have a shape and a size similar to those of a common battery of a coin type. It is thus possible to easily replace such a common battery of the coin type with the power supply apparatus 10.

In one example, the power supply apparatus 10 may have a size in a direction in which the primary battery 100 and the secondary battery 200 are bonded to each other (i.e., a height of the power supply apparatus 10) of 5 mm or smaller. In such a case, the power supply apparatus 10 may have a size such that the power supply apparatus 10 is interchangeable with an existing battery of the coin type, particularly with a battery of the coin type for a portable communication apparatus.

Next, a communication apparatus according to an embodiment of the present technology will be described. The communication apparatus according to an embodiment includes the above-described power supply apparatus 10.

Specifically, the communication apparatus according to an embodiment may be a communication apparatus that performs communication of, for example, NB-IoT, LTECAT-M1, LoRaWAN (registered trademark), or Sigfox (registered trademark) for IoT (Internet of Things). Alternatively, the communication apparatus according to an embodiment may be a communication apparatus that performs communication of, for example, LF/RF or UWB (Ultra Wide Band) for RKE (Remote Keyless Entry).

The communication apparatus that performs such communication is easily subjected to a short-time high-load state during communication. Accordingly, it is desirable that the communication apparatus include the power supply apparatus that makes it possible to cope with a large current at a peak time. Further, the communication apparatus that performs such communication performs communication regularly. Accordingly, it is desirable that the communication apparatus include the power supply apparatus that makes it possible to supply the electric power to the communication apparatus over a long period of time without charging or replacing the battery.

The communication apparatus according to an embodiment includes the power supply apparatus 10 that makes it possible to perform the pulse discharging a greater number of times than when the secondary battery 200 is used alone, and that does not include an overcharge control circuit. According to this, it is possible to use the communication apparatus according to an embodiment suitably as the communication apparatus that performs the above-described communication.

### EXAMPLES

Hereinafter, the power supply apparatus according to an embodiment will be described in further detail including with reference to Examples and Comparative examples. Note that the following Examples are each an example for indicating enablement and effects of the power supply apparatus according to an embodiment, and the present technology is not limited to the following Examples.

### Example 1

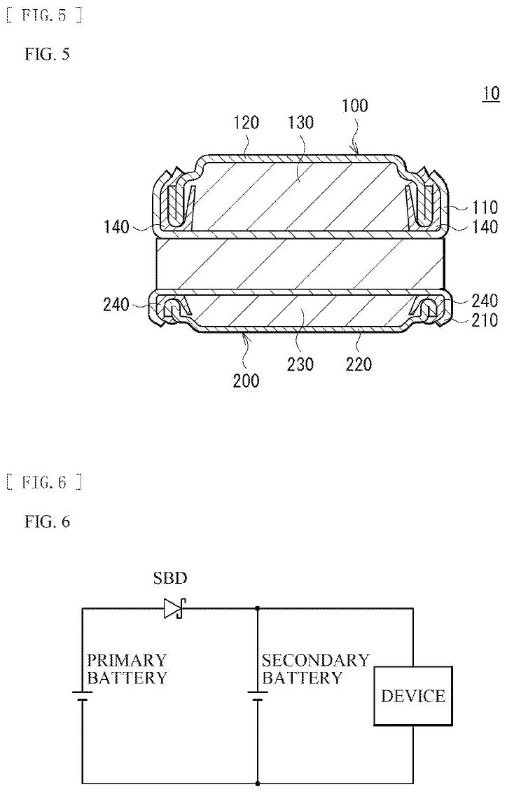

A power supply apparatus according to Example 1 included: a 2450 size manganese dioxide lithium (MnO₂/Li) primary battery; and a 2416 size lithium-ion secondary battery whose positive electrode and negative electrode respectively included lithium iron phosphate and graphite (LiFePO₄/Gr). FIG. 6 illustrates an equivalent circuit diagram of the power supply apparatus according to Example 1.

As illustrated in FIG. 6, the power supply apparatus according to Example 1 included the primary battery, the secondary battery coupled in parallel with the primary battery, and the Schottky barrier diode (SBD) that was the rectifier provided between the primary battery and the secondary battery. The power supply apparatus according to Example 1 supplied the electric power to the device from the secondary battery that was charged by the primary battery.

### Example 2

A power supply apparatus according to Example 2 included: a 2450 size manganese dioxide lithium (MnO₂/Li) primary battery; and a 2416 size lithium-ion secondary battery whose positive electrode and negative electrode respectively included lithium cobalt oxide and graphite (LiCoO₂/Gr). An equivalent circuit of the power supply apparatus according to Example 2 was the same as the equivalent circuit of the power supply apparatus according to Example 1.

### Example 3

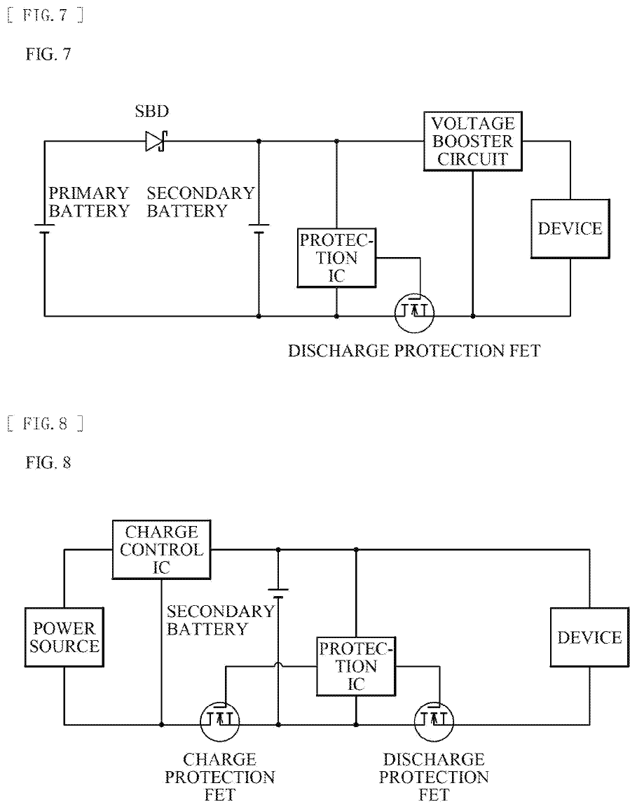

A power supply apparatus according to Example 3 included: a 2450 size manganese dioxide lithium (MnO₂/Li) primary battery; and a 2416 size lithium-ion secondary battery whose positive electrode and negative electrode respectively included lithium cobalt oxide and lithium titanate (LiCoO₂//LTO). FIG. 7 illustrates an equivalent circuit diagram of the power supply apparatus according to Example 3.

As illustrated in FIG. 7, the power supply apparatus according to Example 3 included the primary battery, the secondary battery coupled in parallel with the primary battery, the Schottky barrier diode (SBD) that was the rectifier provided between the primary battery and the secondary battery, a protection IC that controlled a discharge protection FET, and a voltage booster circuit that boosted an output voltage from the secondary battery. The discharge protection FET was provided to protect the secondary battery from, for example, overdischarging, a short circuit, and an overcurrent. The power supply apparatus according to Example 3 was low in output voltage as compared with the respective power supply apparatuses according to Examples 1 and 2, and was thus further provided with the voltage booster circuit. The power supply apparatus according to Example 3 supplied the electric power to the device from the secondary battery that was charged by the primary battery.

### Example 4

A power supply apparatus according to Example 4 included: a 2450 size manganese dioxide lithium (MnO₂/Li) primary battery; and a 2416 size lithium-ion secondary battery whose positive electrode and negative electrode respectively included lithium iron phosphate and lithium titanate (LiFePO₄//LTO). An equivalent circuit of the power supply apparatus according to Example 4 was an equivalent circuit in which a power source in the equivalent circuit of the power supply apparatus according to Example 3 was replaced with the primary battery.

### Example 5

A power supply apparatus according to Example 5 included: a 2450 size thionyl chloride lithium (SOCl₂/Li) primary battery; and a 2416 size lithium-ion secondary battery whose positive electrode and negative electrode respectively included lithium iron phosphate and graphite (LiFePO₄/Gr). An equivalent circuit of the power supply apparatus according to Example 5 was the same as the equivalent circuit of the power supply apparatus according to Example 1.

### Example 6

A power supply apparatus according to Example 6 included: a 2450 size thionyl chloride lithium (SOCl₂/Li) primary battery; and a 2416 size lithium-ion secondary battery whose positive electrode and negative electrode respectively included lithium cobalt oxide and graphite (LiCoO₂/Gr). An equivalent circuit of the power supply apparatus according to Example 6 was the same as the equivalent circuit of the power supply apparatus according to Example 1.

### Example 7

A power supply apparatus according to Example 7 included: a 2450 size thionyl chloride lithium (SOCl₂/Li) primary battery; and a 2416 size lithium-ion secondary battery whose positive electrode and negative electrode respectively included lithium cobalt oxide and lithium titanate (LiCoO₂/LTO). An equivalent circuit of the power supply apparatus according to Example 7 was the same as the equivalent circuit of the power supply apparatus according to Example 3.

### Example 8

A power supply apparatus according to Example 8 included: a 2450 size thionyl chloride lithium (SOCl₂/Li) primary battery; and a 2416 size lithium-ion secondary battery whose positive electrode and negative electrode respectively included lithium iron phosphate and lithium titanate (LiFePO₄/LTO). An equivalent circuit of the power supply apparatus according to Example 8 was the same as the equivalent circuit of the power supply apparatus according to Example 3.

### Example 9

A power supply apparatus according to Example 9 included: a 2450 size alkaline manganese dry battery (MnO₂/Zn); and a 2016 size lithium-ion secondary battery whose positive electrode and negative electrode respectively included lithium cobalt oxide and lithium titanate (LiCoO₂/LTO). An equivalent circuit of the power supply apparatus according to Example 9 was the same as the equivalent circuit of the power supply apparatus according to Example 3.

### Example 10

A power supply apparatus according to Example 10 included: a 2450 size alkaline manganese dry battery (MnO₂/Zn); and a 2016 size lithium-ion secondary battery whose positive electrode and negative electrode respectively included lithium iron phosphate and lithium titanate (LiFePO₄/LTO). An equivalent circuit of the power supply apparatus according to Example 10 was the same as the equivalent circuit of the power supply apparatus according to Example 3.

### Example 11

A power supply apparatus according to Example 11 included: a 2450 size alkaline manganese dry battery (MnO₂/Zn); and a 2016 size lithium-ion secondary battery whose positive electrode and negative electrode respectively included lithium iron phosphate and lithium titanate (LiFePO₄/LTO). An equivalent circuit of the power supply apparatus according to Example 11 was an equivalent circuit in which a power source in an equivalent circuit of a power supply apparatus according to Comparative example 4 to be described later was replaced with the primary battery.

### Example 12

A power supply apparatus according to Example 12 included: a 2450 size alkaline manganese dry battery (MnO₂/Zn); and a 2016 size lithium-ion secondary battery whose positive electrode and negative electrode respectively included lithium iron phosphate and lithium titanate (LiFePO₄/LTO). An equivalent circuit of the power supply apparatus according to Example 12 was an equivalent circuit in which the power source in the equivalent circuit of the power supply apparatus according to Comparative example 4 to be described later was replaced with the primary battery.

### Example 13

A power supply apparatus according to Comparative example 11 included: a 2450 size manganese dioxide lithium (MnO₂/Li) primary battery; and a 2450 size lithium-ion secondary battery whose positive electrode and negative electrode respectively included lithium cobalt oxide and lithium titanate (LiCoO₂/LTO). An equivalent circuit of the power supply apparatus according to Example 13 was the same as the equivalent circuit of the power supply apparatus according to Example 3.

### Comparative Example 1

A power supply apparatus according to Comparative example 1 included a 2450 size manganese dioxide lithium (MnO₂/Li) primary battery.

### Comparative Examples 2 and 3

A power supply apparatus according to Comparative example 2 included a 2450 size lithium-ion secondary battery whose positive electrode and negative electrode respectively included lithium cobalt oxide and graphite (LiCoO₂/Gr). A power supply apparatus according to Comparative example 3 included a 2450 size lithium-ion secondary battery whose positive electrode and negative electrode respectively included lithium iron phosphate and graphite (LiFePO₄/Gr). FIG. 8 illustrates an equivalent circuit of the power supply apparatus according to each of Comparative examples 2 and 3.

As illustrated in FIG. 8, the power supply apparatus according to each of Comparative examples 2 and 3 included the secondary battery, a charge control IC that controlled charging of the secondary battery from an external power source, and a protection IC that controlled a charge protection FET and the discharge protection FET. The charge protection FET was provided to protect the secondary battery from, for example, overcharging, and to prevent zero voltage recharging. The discharge protection FET was provided to protect the secondary battery from, for example, overdischarging, a short circuit, and an overcurrent. The power supply apparatus according to each of Comparative examples 2 and 3 supplied the electric power to the device from the secondary battery that was charged by the external power source.

### Comparative Example 4

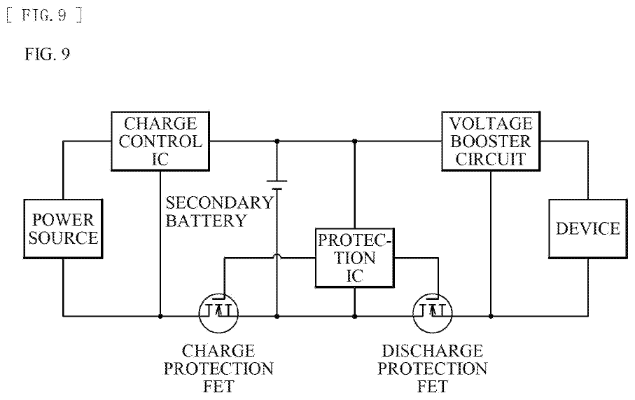

The power supply apparatus according to Comparative example 4 included a 2450 size lithium-ion secondary battery whose positive electrode and negative electrode respectively included lithium cobalt oxide and lithium titanate (LiCoO₂/LTO). FIG. 9 illustrates the equivalent circuit of the power supply apparatus according to Comparative example 4.

As illustrated in FIG. 9, the power supply apparatus according to Comparative example 4 included the secondary battery, the charge control IC that controlled charging of the secondary battery from the external power source, the protection IC that controlled the charge protection FET and the discharge protection FET, and the voltage booster circuit that boosted the output voltage from the secondary battery. The charge protection FET was provided to protect the secondary battery from, for example, overcharging, and to prevent zero voltage recharging. The discharge protection FET was provided to protect the secondary battery from, for example, overdischarging, a short circuit, and an overcurrent. The power supply apparatus according to Comparative example 4 was low in output voltage as compared with the respective power supply apparatuses according to Comparative examples 2 and 3, and was thus further provided with the voltage booster circuit. The power supply apparatus according to Comparative example 4 supplied the electric power to the device from the secondary battery that was charged by the external power source.

### Comparative Example 5

A power supply apparatus according to Comparative example 5 included: a 2450 size manganese dioxide lithium (MnO₂/Li) primary battery; and a 24300 size lithium-ion secondary battery whose positive electrode and negative electrode respectively included lithium cobalt oxide and lithium titanate (LiCoO₂/LTO). An equivalent circuit of the power supply apparatus according to Comparative example 5 was the same as the equivalent circuit of the power supply apparatus according to Example 3.

Table 1 below presents a comparison of configurations and performance between the power supply apparatuses according to Examples 1 to 13 and Comparative examples 1 to 5 described above. Note that it was not possible for the power supply apparatus according to Comparative example 1 to perform discharging at 150 mA or 500 mA and for one second due to a high internal resistance of the primary battery.

The number of times of discharging at 150 mA or 500 mA and for one second was calculated based on a capacity of the secondary battery for each of the power supply apparatuses according to Comparative examples 2 to 5, and based on a capacity of the primary battery for each of the power supply apparatuses according to Examples 1 to 13.

Note that the discharging at 150 mA or 500 mA and for one second was performed as 2.2 V cut-off discharging. At this time, each of the power supply apparatuses was boosted with the voltage booster circuit on an as-needed basis. It was assumed that 10% to 15% electric power loss occurred when boosting by the voltage booster circuit was performed. Specifically, in the power supply apparatuses according to Comparative example 4, Examples 3, 7, 9, and 11 to 13, and Comparative example 5, it was assumed that 10% electric power loss occurred due to the boosting for the 2.2 V cut-off discharging. In the power supply apparatuses according to Examples 4, 8, and 10, it was assumed that 15% electric power loss occurred due to the boosting for the 2.2 V cut-off discharging. Further, in the power supply apparatus according to Example 11, the voltage booster circuit was necessary in charging the secondary battery by the primary battery, it was thus assumed that 30% electric power loss occurred due to the boosting during the charging. In the power supply apparatus according to Example 12, the voltage booster circuit was necessary in charging the secondary battery by the primary battery, it was assumed that 25% electric power loss occurred due to the boosting during the charging.

TABLE 1

| | Primary battery | | | | Secondary battery | | | | | |
|---|---|---|---|---|---|---|---|---|---|---|
| | | Working | | | | Working | | | Primary battery | |
| | | voltage | Battery | | | voltage | | | capacity > | Intersection |
| | Kind of | range | capacity | Battery | Kind of | range | Capacity | Battery | secondary | of discharge |
| | battery | [V] | [mAh] | size | battery | [V] | [mAh] | size | battery capacity | curves |
| Comparative | MnO₂/Li | 3.0-2.0 | 610 | 2450 | — | — | — | — | — | Absent |
| example 1 | | | | | | | | | | |
| Comparative | — | — | — | — | LiCoO₂/Gr | 4.4-3.0 | 161 | 2450 | — | Absent |
| example 2 | | | | | | | | | | |
| Comparative | — | — | — | — | LiFePO₄/Gr | 3.6-2.0 | 87 | | — | Absent |
| example 3 | | | | | | | | | | |
| Comparative | — | — | — | — | LiCoO₂/LTO | 2.9-1.0 | 120 | | — | Absent |
| example 4 | | | | | | | | | | |
| Example 1 | MnO₂/Li | 3.0-2.0 | 610 | 2450 | LiFePO₄/Gr | 3.6-2.0 | 28 | 2416 | Yes | Present |
| Example 2 | | | | | LiCoO₂/Gr | 4.4-3.0 | 52 | | Yes | Present |
| Example 3 | | | | | LiCoO₂/LTO | 2.9-1.0 | 38 | | Yes | Absent |
| Example 4 | | | | | LiFePO₄/LTO | 2.35-0.5 | 33 | | Yes | Absent |
| Example 5 | SOCl₂/Li | 3.6-3.0 | 500 | | LiFePO₄/Gr | 3.6-2.0 | 28 | | Yes | Present |
| Example 6 | | | | | LiCoO₂/Gr | 4.4-3.0 | 52 | | Yes | Present |
| Example 7 | | | | | LiCoO₂/LTO | 2.9-1.0 | 38 | | Yes | Absent |
| Example 8 | | | | | LiFePO₄/LTO | 2.35-0.5 | 33 | | Yes | Absent |
| Example 9 | MnO₂/Zn | 1.5-0.5 | 280 | | LiCoO₂/LTO | 2.9-1.0 | 24 | 2016 | Yes | Present |
| Example 10 | (Alkaline) | | | | LiFePO₄/LTO | 2.35-0.5 | 20 | | Yes | Present |
| Example 11 | | | | | LiFePO₄/Gr | 3.6-2.0 | 16 | | Yes | Absent |
| Example 12 | | | | | LiCoO₂/Gr | 4.4-3.0 | 32 | | Yes | Absent |
| Example 13 | MnO₂/Li | 3.0-2.0 | 610 | | LiCoO₂/LTO | 2.9-1.0 | 120 | 2450 | Yes | Absent |
| Comparative | | | | | LiCoO₂/LTO | 2.9-1.0 | 720 | 24300 | — | Absent |
| example 5 | | | | | | | | | | |

| | | Performance | | | | |
|---|---|---|---|---|---|---|
| | | | | | Number of times | Number of times |
| | | | Necessity of | Volume | of discharging | of discharging |
| | Depth of | Necessity of | voltage booster | energy | at 150 mA and | at 500 mA and |
| | discharge at | charge control | circuit during | density | for 1 sec. | for 1 sec. |
| | intersection | circuit | discharging | [Wh/L] | [times] | [times] |
| Comparative | — | Unnecessary | Unnecessary | 809 | Undischargeable | Undischargeable |
| example 1 | | | | | | |
| Comparative | — | Necessary | Unnecessary | 193 | 3864 | 1159 |
| example 2 | | | | | | |
| Comparative | — | Necessary | Unnecessary | 104 | 2088 | 626 |
| example 3 | | | | | | |
| Comparative | — | Necessary | Necessary | 144 | 2880 | 864 |
| example 4 | | | | | | |
| Example 1 | 5% | Unnecessary | Unnecessary | 613 | 15312 | 4594 |
| Example 2 | 1% | Unnecessary | Unnecessary | 613 | 15888 | 4766 |
| Example 3 | — | Unnecessary | Necessary | 424 | 13997 | 4199 |
| Example 4 | — | Unnecessary | Necessary | 400 | 13117 | 3935 |
| Example 5 | 99% | Unnecessary | Unnecessary | 603 | 12672 | 3802 |
| Example 6 | 15% | Unnecessary | Unnecessary | 603 | 13248 | 3974 |
| Example 7 | — | Unnecessary | Necessary | 347 | 11621 | 3486 |
| Example 8 | — | Unnecessary | Necessary | 328 | 10873 | 3262 |
| Example 9 | 2% | Unnecessary | Necessary | 186 | 6566 | 1970 |
| Example 10 | 2% | Unnecessary | Necessary | 175 | 6120 | 1836 |
| Example 11 | — | Necessary | Necessary | 144 | 4973 | 1492 |
| Example 12 | — | Necessary | Necessary | 155 | 5616 | 1685 |
| Example 13 | — | Unnecessary | Necessary | 270 | 14016 | 4205 |
| Comparative | 85% | Unnecessary | Necessary | 88 | 25536 | 7661 |
| example 5 | | | | | | |

As presented in Table 1, it was possible for the power supply apparatuses according to Examples 1 to 13 to perform the pulse discharging (for example, the pulse discharging at 150 mA and for one second, or at 500 mA and for one second) a greater number of times than when the secondary battery was used alone.

In particular, the power supply apparatuses according to Examples 1, 2, 5, and 6 each had a simple circuit, and were thus advantageous in terms of electric power loss, cost, and miniaturization. This makes it possible to further increase a volume energy density. The power supply apparatuses according to Examples 3, 4, and 7 to 13 each used the voltage booster circuit for performing the 2.2 V cut-off discharging, thus causing the electric power loss and a decrease in volume energy density as compared with the power supply apparatuses according to Examples 1, 2, 5, and 6.

In contrast, although the power supply apparatus according to Comparative example 1 was advantageous in terms of cost and miniaturization owing to its simple circuit, it was difficult to perform high-output pulse discharging because the discharging was performed from the primary battery. Further, the number of times of the pulse discharging performed by the power supply apparatuses according to Comparative examples 2 to 4 decreased owing to the fact that the secondary battery was used alone in each of the power supply apparatuses. In addition, in the power supply apparatus according to Comparative example 5, the discharge capacity of the primary battery was larger than the discharge capacity of the secondary battery. Accordingly, the power supply apparatus according to Comparative example 5 was markedly low in volume energy density as compared with the power supply apparatuses according to Examples 1 to 13.

Although the present technology has been described herein including with reference to one or more embodiments including Examples, the configuration of the present technology is not limited thereto, and is therefore modifiable in a variety of suitable ways.

The effects described herein are mere examples, and effects of the present technology are therefore not limited to those described herein. Accordingly, the present technology may achieve any other suitable effect.

It should be understood that various changes and modifications to the embodiments described herein will be apparent to those skilled in the art. Such changes and modifications can be made without departing from the spirit and scope of the present subject matter and without diminishing its intended advantages. It is therefore that such changes and modifications be covered by the appended claims.

1. A power supply apparatus comprising:
a primary battery;
a secondary battery coupled in parallel with the primary battery; and
an output terminal that outputs electric power from the secondary battery to an outside, wherein
a discharge capacity of the primary battery is larger than a discharge capacity of the secondary battery.

2. The power supply apparatus according to claim 1, wherein a discharge curve of the secondary battery intersects a discharge curve of the primary battery.

3. The power supply apparatus according to claim 2, wherein the discharge curve of the secondary battery intersects the discharge curve of the primary battery at a point at which a depth of discharge of the primary battery is greater than 0 percent and less than or equal to 99 percent.

4. The power supply apparatus according to claim 1, wherein the secondary battery is coupled to the primary battery without a charge control circuit being interposed between the secondary battery and the primary battery.

5. The power supply apparatus according to claim 1, wherein the secondary battery is coupled to the output terminal without a discharge protection circuit being interposed between the secondary battery and the output terminal.

6. The power supply apparatus according to claim 1, further comprising a rectifier provided between the primary battery and the secondary battery, the rectifier setting a direction in which a current flows from the primary battery to the secondary battery to a forward direction.

7. The power supply apparatus according to claim 1, wherein
the primary battery comprises a lithium primary battery, and
the secondary battery comprises a lithium secondary battery.

8. The power supply apparatus according to claim 1, wherein
the primary battery comprises a lithium manganese dioxide battery, and
the secondary battery comprises a lithium-ion secondary battery, the lithium-ion secondary battery including a positive electrode and a negative electrode, the positive electrode including a lithium-containing compound having an olivine structure, the negative electrode including one or more of graphite, a silicon-containing compound, or a tin-containing compound.

9. The power supply apparatus according to claim 1, wherein a planar shape of the primary battery is substantially similar to a planar shape of the secondary battery.

10. The power supply apparatus according to claim 1, wherein the primary battery and the secondary battery each have a flat columnar shape.

11. The power supply apparatus according to claim 1, wherein the primary battery is provided to be replaceable.

12. A communication apparatus comprising
a power supply apparatus, the power supply apparatus including
a primary battery,
a secondary battery coupled in parallel with the primary battery, and
an output terminal that outputs electric power from the secondary battery to an outside, wherein
a discharge capacity of the primary battery is larger than a discharge capacity of the secondary battery.
